(19) United States
(12) Patent Application Publication
(10) Pub. No.: US 2006/0036720 A1
(43) Pub. Date: Feb. 16, 2006

(54) Rate limiting of events

(76) Inventor: Robert L. Faulk JR., Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/868,093

(22) Filed: Jun. 14, 2004

(51) Int. Cl. G06F 15/173

(52) U.S. Cl. 709/223

(57) ABSTRACT

In an embodiment, a method for rate limiting of events includes: monitoring and processing an event instance of an event type; and if a value of the event instance to be monitored meets or exceeds an associated suspension threshold value, then performing a user-defined action for the event instance. The method may also comprise resuming the suspended event instance. The suspended event instance may be resumed, for example, after a suspension time value has elapsed. Additionally or alternatively, the suspended event instance may be resumed, for example, after a value of the event instance falls below the resumption threshold value. In another embodiment, an apparatus for rate limiting of events includes: a rate limiter configured to monitor and process an event instance of an event type, and perform a user-defined action for the event instance, if a value of the event instance to be monitored exceeds an associated suspension threshold value.

### TECHNICAL FIELD

Embodiments of the invention relate generally to network systems, and more particularly to an apparatus and method for rate limiting of events. In an embodiment of the invention, the events may be arbitrarily selected for suppression and resumption.

### BACKGROUND

Previous solutions have been developed to limit the rate of servicing of a particular type of event(s) in a network. For example, in Ethernet network switches, previous methods have been developed to identify network conversations and to limit the network bandwidth for each conversation. Typically, these previous implementations are hard-wired to examine a certain portion of the network packets such as, for example, the source address and the destination address within a packet, and a Content Addressable Memory (CAM) is used to locate the count of packets for each conversation. In these previous implementations, unique hardware or software is required to be developed to limit the network bandwidth for the particular conversation. For example, to limit a be developed to limit the network bandwidth for the particular conversation. For example, to limit a particular network conversation such as an http-based (hypertext transfer protocol based) denial-of-service (DoS) attack, hardware or software is required to be developed to limit an http-based denial-of-service attack.

In the previous implementations, if a new type of network traffic (for example, an Ethernet Broadcast storm) needs to be rate limited, then a new search mechanism must be developed to rate limit this new type of network traffic. This new search mechanism involves the required development of a new additional code for rate limiting for the new type of network traffic. As a specific example, in order to rate limit other types of denial-of-service attacks, the development of new additional hardware or software is required to achieve this rate limiting functionality.

As another example, in previous approaches, if an Ethernet switch needs to limit that amount of network bandwidth used by a particular port, then a mechanism or new additional code would also be needed to perform the bandwidth limiting functionality. For example, a table might be implemented which tracks the network bandwidth for each port. When excessive bandwidth is used by a particular port, then the Ethernet switch might disable further packets from being received on the particular port in order to limit the bandwidth that is used. However, this existing specific procedure is incapable of rate limiting of other types of events such as, for example, the number of new network connections. New methods are required to be implemented for limiting each new type of event, and the new methods will require the development of new or additional hardware or software.

Other previous methods can limit the network traffic for a given network traffic flow. These previous methods use a fixed-format set of inputs, typically formed by source addresses and destination addresses. These source addresses and destination addresses form a flow. For each flow, a rate limit is enforced. However, these previous methods are inflexible and must be created specifically for the type of addresses used. Furthermore, the actions taken when the rate limits are exceeded or when the rate returns to normal are inflexible and cannot be easily changed.

Therefore, the current technology is limited in its capabilities and suffers from at least the above constraints and deficiencies.

### SUMMARY OF EMBODIMENTS OF THE INVENTION

In an embodiment of the invention, a method for rate limiting of events includes: monitoring and processing an event instance of an event type; and if a value of the event instance to be monitored exceeds an associated suspension threshold value, then performing a user-defined action for the event instance.

A value of the event instance to be monitored comprises, for example, a count of the event instance in an interval time period.

The action of performing the user-defined action may comprise, for example, suspending the event instance.

The method may also comprise resuming the suspended event instance.

The suspended event instance may be resumed, for example, after a suspension time value has elapsed. Additionally or alternatively, the suspended event instance may be resumed, for example, after a value (e.g., a count) of the event instance no longer exceeds the suspension threshold value. Additionally or alternatively, the suspended event instance may be resumed, for example, after a value of the event instance falls below the resumption threshold value.

In another embodiment of the invention, an apparatus for rate limiting of events includes: a rate limiter configured to monitor and process an event instance of an event type, and perform a user-defined action for the event instance, if a value of the event instance to be monitored exceeds an associated suspension threshold value.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of a network (system), in accordance with an embodiment of the invention.

FIG. 2 is a block diagram of a rate limiter in a network device, in accordance with an embodiment of the invention.

FIG. 3 is a block diagram of a global event state data, in accordance with an embodiment of the invention.

FIG. 4 is a block diagram shown to illustrate a hash operation of a rate limiter, in accordance with an embodiment of the invention.

FIG. 5 is a block diagram of per-event instances hash data structures, in accordance with an embodiment of the invention.

FIG. 6 is a table that lists various flags for events, as used in accordance with an embodiment of the invention.

FIG. 7 is a flowchart of a method for rate limiting of events in a network, in accordance with an embodiment of the invention.

FIG. 8 is a flowchart of a method for resuming the rate limited events in a network, in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

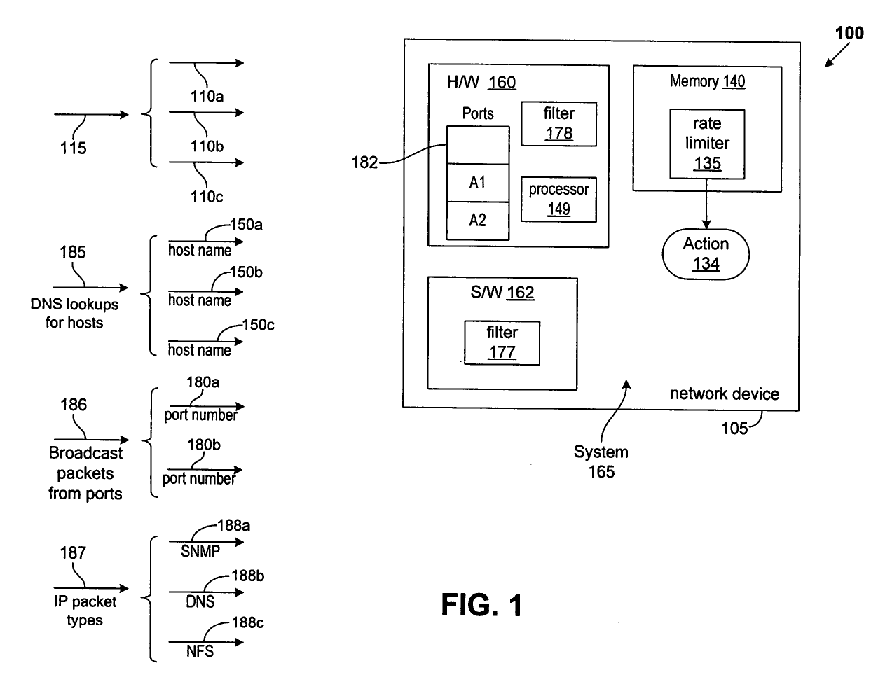

FIG. 1 is a block diagram of a network (system) 100, in accordance with an embodiment of the invention. The network 100 includes a network device (apparatus) 105, in accordance with an embodiment of the invention. In particular, the network device 105 provides for customized limiting of different instances (generally shown as event instances 110) of different types 115 of events. An event type 115 identifies the type of event that occurs in the network 100, and is defined further below.

An embodiment of the network device 105 provides a generalized mechanism and/or method to limit the rate of servicing of different event types 115. By rate limiting a particular event type(s) 115, the processing tasks for the rate limited event type 115 is reduced and other event types 115 can be serviced or other tasks can be processed by the network device 105.

The network device 105 may be, for example, a network switch or another suitable device that is used in the network 100 for processing of network traffic.

In FIG. 1, the event instances 110 are shown as event instances 110a-110c. However, the number of event instances 110 that the network device 105 can monitor and suspend (and resume) may vary, as configured by the user. The number event types 115 may also vary, as configured by the user, and may be arbitrarily selected or configured by the user for monitoring and suspension (and resumption).

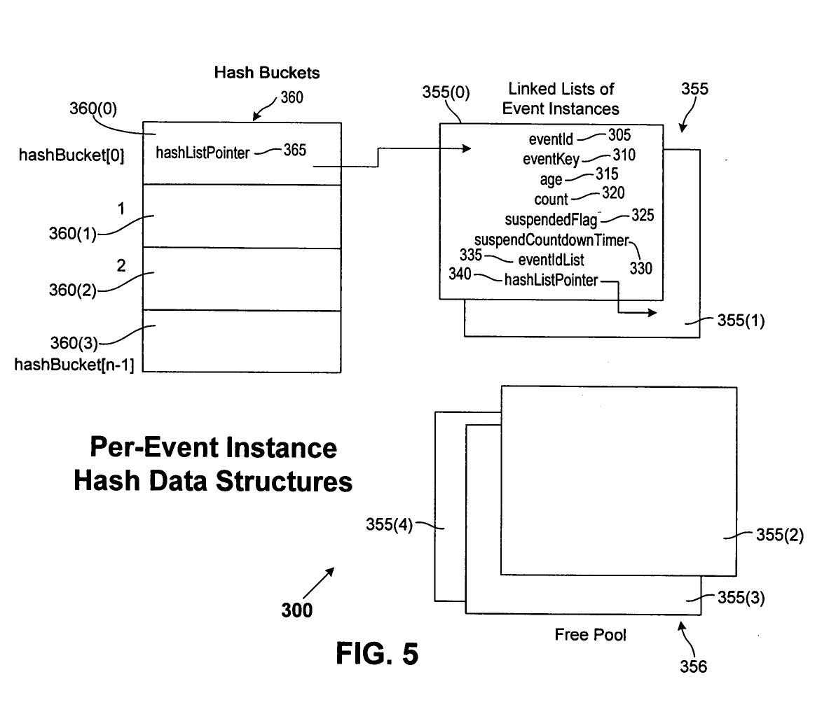

An identifier, eventId 305 (see FIG. 5), identifies a particular event type 115. An event instance 110 is a particular instance of an event type 115, and is defined further below. Each particular event type 115 will have an associated eventId 305 for the purpose of identifying that particular event type 115.

An identifier, eventKey 310 (FIG. 5), identifies a particular event instance 110. Each particular event instance 110 will have an associated eventKey 310 for the purpose of identifying that particular event instance 110. The eventKey 310 is typically a variable length search key that is used to identify a specific instance 110 of an event type 115. The length of the search key may typically vary.

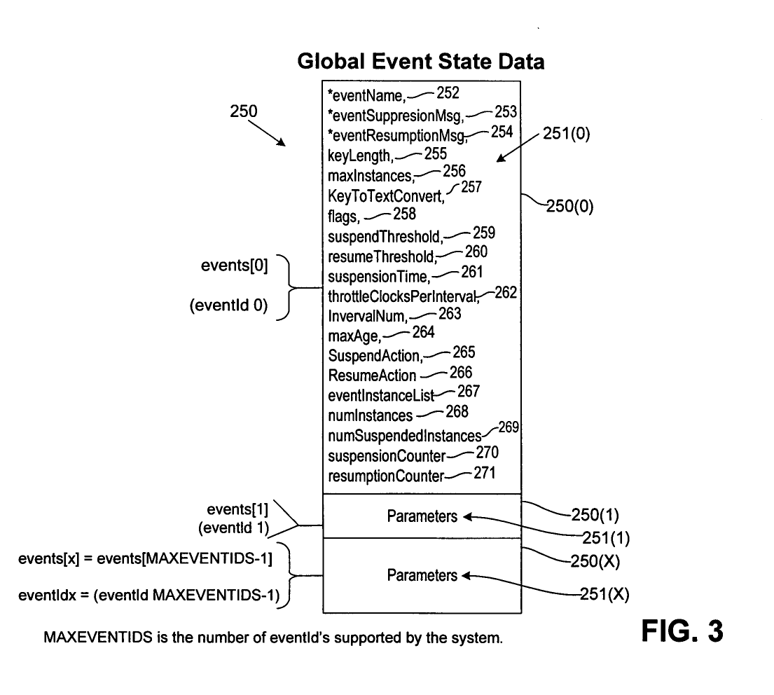

An occurrence count value 320 (FIG. 5) is the number of times that a particular event instance 110 has been observed by the network device 105 (i.e., a count of the event instance 110 in an interval time period). The occurrence for each event instance 110 of each event type 115 is tracked by a counter function of the rate limiter 135. When the occurrence count value 320 for a given event instance 110 of a given event type 115 exceeds a threshold value (suspendThreshold values 259 in FIG. 3) as detected by the rate limiter 135 in the network device 105, then a user-defined action 134 is performed by a rate limiter 135 in accordance with an embodiment of the invention. The software or routines in the rate limiter 135 are typically stored in a memory 140. A processor 149 will execute the software and routines in the rate limiter 135. The rate limiter 135 will perform a user-defined action 134 such as, for example, preventing the network device 105 from processing of further occurrences of an event instance 110 that exceeds the suspension threshold value 259. As an example, the rate limiter 135 may enable a standard software network filter 177 or standard hardware network filter 178 for filtering packets 180 at a port 182 (where the event instance 110 is defined in this example as the packets 180 at the ports 182), since the event instance 110 has exceeded an associated suspension threshold value 259. The rate limiter 135 may then disable the standard software network filter 177 or standard hardware network filter 178, after event instance 110 falls below the resumption threshold value 260 or/and after a suspension time value 261 has elapsed. Alternatively, the rate limiter 135 may then disable the standard software network filter 177 or standard hardware network filter 178, after event instance 110 no longer exceeds the associated suspension threshold value 259.

The network device 105 includes standard network device hardware 160 and standard network device software 162 for processing and filtering of packets 180. Typically, the hardware 160 includes ports 182, switching fabric including switch control (if the network device 105 is a switch), buffers, memory, filters, and/or other suitable components for controlling network packet traffic flow. Typically, the software 162 includes packet processing software, filters, and/or other software or firmware for controlling network packet traffic flow.

Generically, for purposes of defining the terms “event type” and “event instance”, an example of an event type 115 may be generically viewed as “automobile colors” (colors of automobiles), and one example of an event instance 110 may be the color, blue. The color, red, may be another example of another event instance 110. The occurrence count value 320 for an event instance 110 of blue would be the number of blue cars that are observed.

One specific example of an event type 115 might be DNS lookups for network hosts 185. An example of an event instance 110 for this event type 115 of the particular network host is the name of the particular network host 150a (e.g., the host 150a has a name of <bobf.rose.hp.com>). Another event instance 110 for this event type 115 of DNS lookup packets 185 would be the name of another network host 150b. Yet another event instance 110 for this event type 115 would be the name of another network host 150c. As discussed below, a hash is performed on a network host name for DNS lookup packets 185, in order to determine if rate limiting will be performed for an event instance of a network host name. An occurrence count 320 for the event instance 110 could be, for example, the number of observed DNS (Domain Name Service) lookup packets 185 for the host name 150a of <bobf.rose.hp.com>. As known to those skilled in the art, DNS is the way that Internet domain names are located and translated into Internet Protocol addresses. A domain name is a meaningful and easy-to-remember “handle” for an Internet host. A DNS server may be within close geographic proximity to an access provider that maps the domain names for Internet requests or forwards the Internet requests to other servers in the Internet.

The rate limiter 135 then performs a user-defined action 134 if the occurrence count 320 associated for the event instance 110 exceeds a suspension threshold value 259 (FIG. 3) associated with the event instance 110. For example, if the number of DNS lookup packets 185 received by the network device 105 for <bobf.rose.hp.com> exceeds an associated suspension threshold value 259 of, e.g., approximately 500 packets, in an interval time period (intervalNum 263) (see FIG. 3) of, for example, approximately one minute, then that event instance 150a of DNS lookup packets 185 for <bobf.rose.hp.com> has exceeded the associated suspension threshold value 259, and the rate limiter 135 then performs a user-defined action 134. For example, this user-defined action 134 is the network device 105 dropping further observed DNS lookup packets 185 for <bobf.rose.hp.com> for a suspension time value 261 (FIG. 3) and/or until the value (count) of DNS lookup packets 185 for <bobf.rose.hp.com> decreases below the associated resumption threshold value 260. In other words, the rate limiter 135 will suspend the event instance 150a of DNS lookup packets 185 for <bobf.rose.hp.com>, for the time length of the suspension time value 261 if the number of DNS lookup packets 185 exceeds the associated suspension threshold value 259, or/and will suspend the event instance 150a of DNS lookup packets 185 for <bobf.rose.hp.com> until the value (rate) of DNS lookup packets 185 for <bobf.rose.hp.com> packets decreases below the associated resumption threshold value 260.

When the rate limiter 135 resumes a suspended event instance 110, the event instance 110 will no longer be suspended. When the event instance 110 is resumed in this example, the network device 105 will no longer drop (filter) the DNS lookup packets 185 for <bobf.rose.hp.com>.

A system 165 of a network device 105 may have limited resources, such as, for example, processing speed, memory, and/or disk storage space. An embodiment of this invention provides a unified and instrumented apparatus 105 and method to limit the rate of servicing of large numbers of events of many different types 115, so as to conserve any type of resource within the network device system 165. As an example, the system 165 may communicate with a large number of hosts (e.g., more than approximately one-thousand hosts) in a network 100, and the network device system 165 may need to limit each individual host to a transmission rate of, for example, approximately 100 packets per second. Therefore, an event instance 110 in this case would be the packets from a particular individual host. In this case, information is maintained for each host on how many packets that each host has sent for each second to the network device 105. This information is contained in an associated count value 320 (FIG. 5), in the example of FIG. 1. A separate count value 320 is maintained for the packets sent by each host. Typically, the names of the hosts are not known in advance, and the rate limiter 135 learns about each newly-discovered host in the network 100.

As another example, assume that the rate limiter 135 can limit the rate of other event instances 110 such as the number of broadcast packets 186 that are received at a particular port 182 in the network device 105. In this case, a separate occurrence count 320 of broadcast packets 186 is maintained by the rate limiter 135 for the particular port number. For example, an occurrence count value 320 may be maintained for broadcast packets 186 from port A1, while another occurrence count value 320 is maintained for broadcast packets from port A2 in the network device 105 if the rate limiter 135 will limit the broadcast packets 186 (or other event types 110) for particular ports 182 in the network device 105. A hash is performed on the port number for broadcast packets 186, in order to determine if rate limiting will be performed for an event instance of a port number. An embodiment of the invention provides a unified method for limiting the many instances 110 of the above-mention types 115 of events and many other types 115 of events as needed or as configured in the system 165.

The rate limiter 135 hashes an identifier (eventKey 310 in FIG. 5) that is associated with a particular instance 110 of an event 115, and maintains a count 320 of the occurrence of observed event instances 110. For example, if the number of DNS lookup packets 185 that are received for an event instance 110a which is a first host name 150a of <bob.doe.rose.hp.com> exceeds an associated preset threshold value 259, while the number of packets DNS lookup packets 185 that are received from an event instance 110b which is a second host name 150b of <john.doe.rose.hp.com> does not exceed an associated preset threshold value 259, then the rate limiter 135 can perform a user-defined action 134 such as, for example, dropping (filtering) the DNS lookup packets 185 for the first host name 150a for a suspension time period 261, while continuing to receive and process the DNS lookup packets 185 for the second host name 150b. A first event key 310 is associated with the first host name 150a and a second event key 310 is associated with the second host name 150b, and a hash is performed by the rate limiter 135 on the first event key 310 and the second event key 310, in order to track the rate of the event instance 110a of the first host name 150a and track the rate of the event instance 110b of the second host name 150b. Thus, the rate limiter 135 allows particular event keys 310 to be registered, and when the particular hash on an event key 310 exceed a certain rate as dictated by a suspension threshold value 259, then a user-defined action 134 is performed such as suspending the DNS lookup packets 185 for a host name 150 that is not well behaved. An event instance 110 which is suspended is defined herein as a “suspended event instance”.

A suspended event instance 110 may then be later resumed as part of the user-defined action 134. For example, if DNS lookup packets 185 for a first host name 150a is suspended by use of the software filter 177 or hardware filter 178, then the rate limiter 135 can later disable the software filter 177 or hardware filter 178 so that the DNS lookup packets 185 for the first host name 150a are no longer filtered.

Therefore, an embodiment of the invention provides a single mechanism or infrastructure to perform the throttling (i.e., suspension and resumption) of event types 115. Different types 115 of events may be throttled using different types of suspend actions and different types resume actions. In an embodiment of the invention, the event types 115 may be arbitrarily selected for suppression and resumption, based on the programming of the rate limiter 135 by the user.

In contrast, previous rate limiting solutions have been developed for specific types of events. For example, existing procedures can limit the number of packets transmitted through an Ethernet switch port. However, those existing procedures are incapable of rate limiting of other types of events such as, for example, the number of new network connections that are formed with the port. In previous solutions, new or additional hardware or software are required to be developed and implemented for limiting each new additional type of event.

In contrast, an embodiment of the invention provides a single procedure that is used for limiting all types 115 of different events, and a general-purpose “eventId” 305 (FIG. 3) and “eventKey” 310 are passed as the input to this procedure. The eventKey 310 is a pointer to a variable-length search key.

In an embodiment of the invention, arbitrarily selected addresses and arbitrarily selected inputs can be rate limited by the rate limiter 135, and arbitrarily defined actions 134 can be performed by the rate limiter 135, based upon the configurations that are programmed by the user into the rate limiter 135. Furthermore, multiple different types 115 of events can be rate limited simultaneously by the rate limiter 135.

In an embodiment of the invention, if the network device 105 is a DNS server, then the rate limiter 135 is used to limit the rate of DNS (Domain Name Service) lookup packets 185 that are serviced on an Ethernet network. In this embodiment, the network device 105 will include standard hardware 160 and standard software 162 for performing the functions of a DNS server. The eventId 305 will indicate “network host name” as the type 115 of event. When a new event instance 110 is discovered by the DNS server (e.g., the hash lookup for the new host name fails to find the host name in the hash table), a new event entry is created which contains the eventKey 310 (which will be the identifier of the newly-learned host name), occurrence count 320, and other information. When the associated occurrence count 320 for that event instance 110 exceeds an associated suspension threshold value 259, the programmed action 134 for that type 115 of event is executed by the DNS server, and a suspended flag (“suspendedFlag” 325 in FIG. 5) is set by the processor 149 to indicate that the suspended threshold value 259 has been exceeded and further event instances 110 of that event type 115 should not be processed by the DNS server. For example, if the DNS lookup packets 185 for a particular host name 150 that are received by the DNS server exceeds an example suspension threshold value 259 of approximately 500 packets within a time interval 263 of, e.g., approximate one minute, then the rate limiter 135 will drop (filter) all additional DNS lookup packets 185 for that particular host name 150 that are received by the DNS server. Thus, if there is a denial-of-service (DoS) attack in which excessive DNS lookups are attempted for a particular host name 150, the DNS lookup packets 185 will be dropped by the DNS server so that system resources in the DNS server are available to process DNS lookup packets 185 for other host names.

Therefore, the rate limiter 135 can detect different types 115 of events and different instances 110 of the event types, and perform a rate limit for at least some of the event instances 110. The rate limiter 135 can detect an occurrence of an event instance 110 (as identified by an identifier, eventKey 310) and register (count the occurrence) any arbitrarily defined (arbitrarily user-selected) event instance 110.

As another example, an event type 115 may be broadcast packets 186 and an event instance 110 may be a broadcast packet 186 from a port number A1 of the network device 105. A different event instance of this same event type 115 may be a broadcast packet 186 from another port number A2 of the network device 105.

As another example, an event type 115 may be the different Internet Protocol (IP) packet types 187, and a hash is performed on the TCP or UDP port number within a packet to distinguish the IP packets of various types. An event instance may be, for example, SNMP (Simple Network Management Protocol) packets 188a, DNS packets 188b, or NFS (Network File System) packets 188c. As known to those skilled in the art, SNMP is the protocol governing network management and the monitoring of network devices and their functions, and is not necessarily limited to TCP/IP networks. SNMP is described formally in the Internet Engineering Task Force (IETF) Request for Comment (RFC) 1157 and in a number of other related RFCs. As an example, an embodiment of the invention can prevent denial-of-service attacks on SNMP if the SNMP packet 188a traffic from a particular host exceeds a preset rate as dictated by an associated suspension threshold value 259. If a particular host is not well behaved (where a host that is not well behaved is defined as a host that sends packet traffic that exceeds the preset rate), then the rate limiter 135 will filter the SNMP packet 188a traffic from the particular host, while continuing to process SNMP packet 188a traffic from other hosts that are well behaved (where a well behaved host is defined as a host that sends packet traffic that does not exceed the preset rate). Therefore, an embodiment of the invention limits the rate of event instances 110 that exceed associated suspension threshold values 259, and does not limit the rate of event instances 110 that do not exceed associated suspension threshold values 259. The event instances 110 that are candidates for rate limiting can be configured by the user in the rate limiter 135.

In FIG. 1, the various software, firmware, or modules can be written in, for example, JAVA, C, C++, VISUAL BASIC, or other suitable programming languages, and can be programmed by use of standard code programming techniques such as, for example, object oriented programming.

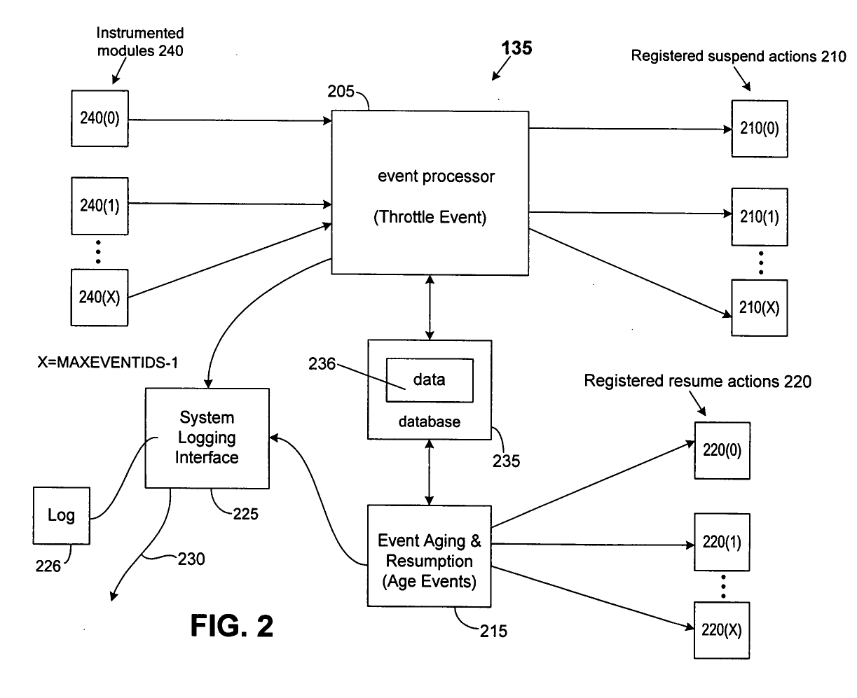

FIG. 2 is a block diagram of a rate limiter 135 in a network device 105, in accordance with an embodiment of the invention. The rate limiter 135 includes an event processing code (throttle event code) 205 which is a code that performs a count for an occurrence of each particular event type 115 and a count for an occurrence of each particular event instance 110. The event processing code 205 also performs calls to other routines or data structures. When the count for a particular event instance 110 exceeds an associated suspension threshold value 259 associated with that particular event instance 110, the event processing code 205 will call a particular registered suspend action routine (generally routine 210) to suspend that event instance 110. A registered suspend action routine 210 is code that permits an associated user-defined action 134 to be performed so that the event instance 110 is suspended. For example, a registered suspend action routine 210 may enable or activate a hardware filter 178 (FIG. 1) or software filter 177 (FIG. 1) that will filter packets at a particular port number(s) in the ports 182 when the rate of packets at the particular port number(s) (i.e., the particular event instance(s) 110) exceeds a packet rate value defined by an associated suspension threshold value 259. In the example of FIG. 2, the number of registered suspend action routines 210 may vary, as dictated by the user, and is specifically shown as routines 210(0), 210(1), and 210(x), where x is equal to maxEventIds-1 which a value of the maximum number of event identifiers (eventIds 305) supported by the system 165 minus a value of 1. Each event identifier 305 is associated with a corresponding event type 115. Therefore, if there are ten (10) event types 115, then x will have a value of nine (9) (i.e., x=10−1).

As an example, the registered suspend action 210(0) may be a routine to suspend DNS lookup packets 185 for a given host name 150a, identified by eventKey 310 (FIG. 5). Alternatively, as another example, the registered suspend action 210(1) may be a routine to suspend broadcast packets 186 at a given port number (e.g., port A1 in FIG. 1), identified by another eventKey. As a further example, the registered suspend action 210(x) may be a routine to suspend an observed IP packet 187 of a particular type(s) such as SNMP packets 188a, DNS packets 188b, and/or NFS packets 188c, as identified by eventKey.

The event aging and resumption code (age events code) 215 performs calls to other routines. For example, the event aging and resumption code (age events code) 215 will call a registered resume action routine (generally, routine 220) to resume a particular suspended event instance 110, if the particular suspended event instance 110 no longer has a value (rate) above the suspension threshold value 259 and/or if a suspension time value 261 has elapsed after the particular event instance 110 was suspended by the event processing code 205, and/or if a value of the suspended event instance falls below the resumption threshold value 260. A registered resume action routine 220 is code that permits an associated user-defined action 134 to be performed, where the particular user-defined action 134 will resume a suspended event instance 110. For example, a registered resume action routine 220 may disable or deactivate a hardware filter 178 or software filter 177 that is filtering packets at a particular port number(s) (e.g., port A1 or/and port A2) when a value (rate) of the packets at the particular port are less than the resumption threshold value 260 and/or when a suspension time value 261 has expired. In the example of FIG. 2, the number of registered resume action routines 220 may vary, as dictated by the user, and is specifically shown as routines 220(0), 220(1), and 220(x).

As an example, the registered resume action 220(0) may be a routine to resume DNS lookup packets 185 for a given host name 150, identified by eventKey. Alternatively, as another example, the registered resume action 220(1) may be a routine to resume broadcast packets 186 at a particular port number(s), identified by eventKey. As a further example, the registered resume action 220(x) may be a routine to terminate the filtering of particular IP packet types 187 such as, for example, SNMP packets 188a, DNS packets 188b, or/and NFS packets 188c, all identified by eventKey.

As an option, the event aging and resumption code 215 also examines each event instance 110 and will delete an identifier, eventKey 310, associated with a particular event instance 110 if the particular event instance 110 does not occur (i.e., is not observed by the network device 105) within a maximum age time value 264 (FIG. 3). A deleted eventKey 310 will cause the event processor 205 to place all parameters in a linked list 355 of that eventKey 310 in a free pool 356 (FIG. 5). A previously deleted eventKey 310 associated with the particular event instance 110 will be re-created by the event processor 205 if it is observed again. A system logging interface 225 can store a log 226 and provides a notification 230 to the user, when an event instance 110 is suspended or resumed. The event processor code 205 will enter a log entry in the log 226 to indicate a suspended event instance 110 after suspending the event instance 110, while the age events code 215 will enter a log entry in the log 226 to indicate a resumed event instance 110 after resuming the suspended event instance 110. Therefore, the user is notified on the status of event instances 110 via the system logging interface 225. In contrast, in previous approaches, when a suspended event is resumed, there is no user notification that the suspended event has been resumed. Additionally, other previous approaches do not resume a suspended event.

An event state database (or data storage unit) 235 typically stores the event state data 236 that includes the global event state data 250 (FIG. 3) and the per-event instance hash data structures 300 (FIG. 5). The event state database 235 is accessed by the event processing code 205 and the event aging and resumption code 215 in order to perform the various functionalities discussed herein.

The instrumented modules (generally 240) are typically conventional hardware, software, and/or firmware elements that detect (and receive or process) the event types 115 and event instances 110. Typically, the instrumented modules 240 are in the standard hardware 160 (FIG. 1) and/or in the standard software 162 of the network device 105. For example, the instrumented module 240(0) may detect (and receive or process) DNS lookup packets 185, the instrumented module 240(1) may detect (and receive or process) broadcast packets 186, and the instrumented module 240(x) may detect and distinguish between the various types of IP packets 187. In the example of FIG. 2, the number of instrumented modules 240 may vary, as dictated by the user (or may be combined in functionality in a single block, depending on the configuration and/or constraints in the standard hardware element 160 and/or standard software element 162).

FIG. 3 is a block diagram of a global event state data 250, in accordance with an embodiment of the invention. As mentioned above, this data 250 is typically stored in a database (or data storage unit) 235 (FIG. 2). Each event type 115 (generally denoted as events[ ]) will have an associated event state data, 250. For example, a first event type (events[0]), with associated event identifier (eventId 0), has an associated event state data 250(0). A second event type (events[1]), with associated event identifier (eventId 1), has an associated event state data 250(1). Another event type (events[x]), with associated event identifier (eventId x), has an associated event state data 250(x), where x=MAXEVENTIDS-1. The number of event state data 250 may vary and will be equal to the number of corresponding event types 115 minus one (1).

Each event state data 250 will have associated parameters 251, as discussed below. For example, the event state data 250(0) will include the parameters 251(0), the event state data 250(1) will include the parameters 251(1), and the event state data 250(x) will include the parameters 251(x).

As an example, the parameters 251(0) in the event state data 250(0) will include the following parameter types or variables described below. It is understood that the parameters 251(1) and 251(x) and other parameters for other event state data 250 will have similar parameter types, routines, or variables as in parameters 251(0).

The *eventName parameter 252 is a human readable text string for an event type 115 (e.g., event type events[0]). For example, the *eventName 252 will show in the system logging interface 225 (FIG. 2), the text “DNS lookup request” if the event type events[0] is a DNS lookup request 185 as observed by the standard hardware 160 and/or standard software 162 in the network device 105.

The *eventSuppressionMsg parameter 253 is a human readable text that is logged into the system logging interface 225 (FIG. 2) when an event type 115 (e.g., event type events[0]) is suspended.

The *eventResumptionMsg parameter 254 is a human readable text that is logged into the system logging interface 225 (FIG. 2) when the event type (e.g. events[0]) is resumed after the event type has been previously suspended.

The keyLength parameter 255 is the number of bytes of a hash key that is used in accordance with an embodiment of the invention. For example, for broadcast packets 186, if the hash key indicates a port number (in ports 182) that received the broadcast packets 186, then the keyLength parameter 255 will indicate a length of, for example, approximately 1 byte. For DNS lookup packets 185, the keyLength parameter 255 will indicate a length of, for example, approximately 255 bytes because a DNS name is typically a variable length string of up to approximately 255 bytes.

The maxInstances parameter 256 is the number of unique event instances 110 (of the event type event[0]) that will be detected by the rate limiter 135. For example, for a DNS throttling mechanism which will suspend and resume DNS lookup packets 185 for one or more network host names, the maxInstances parameter 256 will indicate the maximum number of hosts for which DNS lookup packets 185 will be tracked and counted by the rate limiter 135. As another example, if broadcast packets 186 will be tracked per port for particular ports (e.g., port A1 or port A2 in FIG. 1), then the maxInstances parameter 256 will indicate the number of particular ports where broadcast packets 186 will be tracked by the rate limiter 135.

The KeyToTextConvert routine 257 permits a binary key to be converted into a human-readable string. For example, for broadcast packets 186 at a particular port number in the network device 105, the particular port number may have an identification indicating a key value of, e.g., 1 to 100), but an actual network switch 105 may have ports that are labeled, for example, A1 through A24, and B1 through B24. The KeyToTextConvert routine 257 provides a subroutine that would convert the key value into human readable text, so that the user can read the actual port name of the port that receives the observed broadcast packets 186, for example.

The flags parameter 258 was previously discussed above and indicates if a suspension threshold value 259 has been exceeded by an event instance 110 (of the event type event[0]) and further event instances 110 should not be processed by the network device 105.

The suspendThreshold parameter 259 is the value (e.g., rate) above which an event instance 110 (of the event type event[0]) will be suspended. For example, to track an event instance 110 of broadcast packets 186 at a particular port number, by setting the suspendThreshold parameter 259 to, for example, approximately 100 packets, broadcast packets 186 at the particular port number will be dropped if the rate of the broadcast packets 186 exceeds the rate of approximately 100 packets at that particular port number over the measurement interval.

The resumeThreshold parameter 260 is the value (e.g., rate) below which a suspended event instance 110 (of the event type event[0]) will be resumed. For example, by setting the resumeThreshold parameter 260 to, for example, approximately 100 packets, broadcast packets 186 at the particular port number will no longer be dropped if the rate of the broadcast packets 186 falls below the rate of approximately 100 packets at that particular port number over the measurement interval. It is noted that this resumeThreshold parameter 260 is an optional feature. The suspendThreshold parameter 259 may simultaneously be used as a threshold value below which a suspended event instance 110 will be resumed.

The suspensionTime parameter 261 is the suspension time length that an event instance 110 (of the event type event[0]) is suspended, when the event instance 110 exceeds the threshold value 259. The suspended event instance 110 is resumed after this suspension time length 261 has elapsed. For example, if the number of broadcast packets 186 being received at a particular port number exceeds the suspension threshold value 259, then additional broadcast packets 186 received on that particular port number are dropped for the time amount indicated by the suspension time length 261 (e.g., approximately 5 minutes), and the broadcast packets 186 received on that particular port number will no longer be dropped after the suspension time length 261 has elapsed.

The throttleClocksPerinterval parameter 262 determines the measurement interval for the given eventId. For example, to limit the number of broadcast packets 186 in a ten (10) second measurement interval, the throttleClocksPerinterval parameter 262 should be set to 10, if the system throttleClock is approximately 1 second.

The intervalNum parameter 263, throttleClocksPerInterval 262, and the system throttle clock value determine the measurement interval across which the rate is determined for a given event type 250. The intervalNum parameter 263 indicates which throttleClock interval is being processed for this eventId. All event types 250 of the system share the same throttleClock, and the intervalNum parameter 263 counts the number of throttleClock intervals which have elapsed for each event type 250. The measurement interval for a given event type 250 elapses when the intervalNum 263 reaches the value of throttleClocksPerInterval 262 for the given event type 250. For example, if the system throttle clock is 1 second and the value of throttleClocksPerInterval 262 is configured at 300, then the intervalNum 263 will increment up to 300, at which time the measurement interval will be complete.

The maxAge parameter 264 indicates a maximum age time amount that determines when an identifier, eventKey 310, for an event instance 110 (of the event type event[0]) is deleted when the network device 105 does not observe an occurrence of the event instance 110 within this maximum time age 264.

The SuspendAction routine 265 defines the user-defined action 134 that is taken when an event instance 110 (of the event type event[0]) is suspended. For example, the SuspendAction routine 265 may be an algorithm that filters broadcast packets 186 at a particular port number, if the number of broadcast packets 186 received in the particular port number exceeds the suspension threshold value 259.

The ResumeAction routine 266 defines the user-defined action 134 that is taken when a suspended event instance 110 (of the event type event[0]) is resumed. For example, the ResumeAction routine 266 may be an algorithm that stops the filtering of broadcast packets 186 at a particular port number, if the number of broadcast packets 186 received in the particular port number no longer exceeds a user-defined threshold as set in the suspendThreshold 259 during a measurement interval (intervalNum 263) or/and if the suspension time value (as set in the suspensionTime parameter 261) has elapsed and/or the number of broadcast packets 186 received in the particular port number falls below the resumption threshold value 260 during the measurement interval.

The eventInstanceList parameter 267 is a pointer to a linked list 355 (FIG. 5) of event instances 110. For example, if broadcast packets 186 are received in a first port number A1 (FIG. 1) and broadcast packets 186 are also received in a second port A2, then the eventInstanceList 267 will contain an event instance entry for the first port number A1 and another event instance entry for the second port number A2.

The numInstances parameter 268 is a counter value indicating the number of unique event instances 110 of the event type event [0]).

The numSuspendedInstances parameter 269 is a counter value indicating the number of event instances 110 that have been suspended for this event type events[0].

The suspensionCounter parameter 270 is a counter value indicating how many times servicing of the particular eventInstance 110 has been suspended.

The resumptionCounter data 397 is a counter value indicating the number of times servicing of the particular eventInstance 110 has been resumed after previously being suspended.

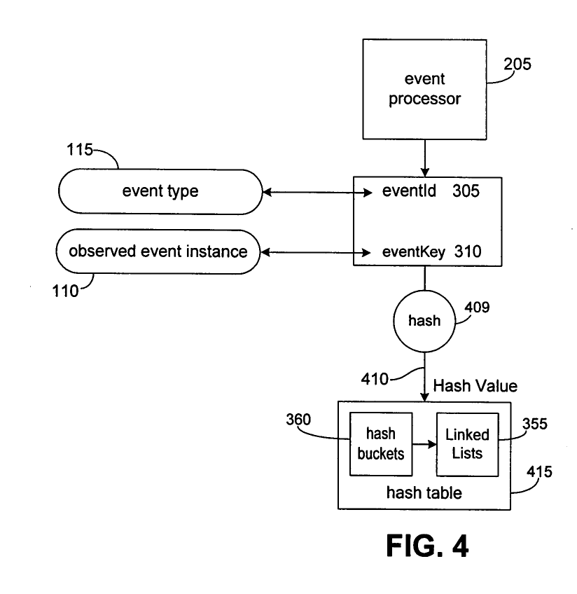

FIG. 4 is a block diagram shown to illustrate a hash operation of a rate limiter 135, in accordance with an embodiment of the invention. As known to those skilled in the art, hashing is the transformation a set of bits, or any numerically represented value, into a usually smaller fixed-length value or address that represents the original value. It is noted that it is within the scope of embodiments of the invention to use all suitable hash functions. Hashing is a scheme for providing rapid access to data items which are distinguished by some key. Each data item to be stored is associated with a key. A hash function is applied to the item's key and the resulting hash value is used as an index to select one of a number of “hash buckets” in a hash table. The table contains pointers to the original items.

To quickly locate the state data 236 (FIG. 2) for a particular event instance 110 observed by the network device 105, hashing is used by the event processing code 205. A has function 409 is applied to the eventId 305 (which is the common identifier for all event instances 110 of a particular event type 115 observed by the network device 105). The hash function 409 is also applied to the eventKey 310 (which is unique to the particular observed event instance 110 of that particular observed event type 115). The eventKey 310 can be of variable length. Once a hash value 410 is determined after applying the hash function 409 to the eventId 305 and eventKey 310, the hash value 410 is used to index into a hash table 415 which contains hash buckets 360 as described below.

FIG. 5 is a block diagram of the per event instance hash data structures 300, in accordance with an embodiment of the invention. The variable “n” is the number of hash buckets 360 used by a hashing algorithm that is used in an embodiment of the invention. For improved performance, the number of hash buckets 360 should be a power of 2.

Each event instance 110 is associated with a linked list entry 355.

An identifier, eventId 305, identifies a particular event type 115. Each event type 115 will have an associated eventId 305 for the purpose of identifying the event type 115. As an example, for a broadcast packet 186 that is received at a port number of the network device 105, the eventId 305 will indicate 0. The eventId 305 will index to the global event state data 250 (FIG. 3) that contains various parameters that determine when an event type 115 is suspended and resumed.

An identifier, eventKey, 310 identifies a particular event instance 110. Each particular event instance 110 will have an associated eventKey 310 for the purpose of identifying that particular event instance 110. As an example, for a broadcast packet 186 that is received at a port number A1 of the network device 105, the eventKey 310 will indicate 1. For a broadcast packet 186 that is received at a port number A2 of the network device 105, a second eventKey 310 will indicate 2; this second eventKey 310 would be contained in another linked list entry (e.g., linked list entry 355(1)). The eventKey 310 is typically a variable length search key that is used to identify a specific instance 110 of the event type 115. The length of the search key may typically vary.

The age parameter 315 defines a current time value of an event instance 110, and is incremented as time passes. When the current time value 315 exceeds the maximum age value 264, then the eventKey 310 for that event instance is deleted. Since the eventKey data structure 310 is deleted, additional memory space is available for use for other functions or for other data structures. A linked list entry 355 with a deleted eventKey 310 is returned to the free pool 356.

An occurrence count value 320 is the number of times that a particular event instance 110 has been observed by the network device 105. The occurrence count value 320 for each event instance 110 of each event type 115 is tracked by a counter function of the rate limiter 135. When the occurrence count value 320 for a given event instance 110 of a given event type 115 exceeds an associated suspension threshold value 259 (FIG. 3) for that event type 115, then a user-defined action 134 is performed by a rate limiter 135 in accordance with an embodiment of the invention. As an example, if approximately 100 broadcast packets 186 are received from the port number A1 within a 5 minute interval, then the count 320 would be 100 for the event instance 110 that is associated with broadcast packets 186 received in port number A1. As another example, an occurrence count 320 for another event instance 110 could be the number of SNMP packets 188a. Therefore, the count 320 is the number of times that a particular event instance 110 has been observed within the measurement time interval 263 (FIG. 3) by the network device 105.

The suspendedFlag 325 is a flag or indicator that indicates if an event instance 110 is currently suspended.

The suspendCountdownTimer 330 is a timer value that will resume a suspended event instance 110 after the expiry of the timer value. For example, if the suspendCountdownTimer 330 is set to approximately 10 minutes, then a suspended event instance 110 will resume after approximately 10 minutes has elapsed after the suspension of the event instance 110. The value of the suspendCountdownTimer 330 is compared with the value 0 by the rate limiter 135, to determine if a suspended event instance 110 will be resumed.

The eventIdList 335 is a link to the list of event instances 110 that are associated with an eventId 305 (i.e., a list of event instances 110 that are associated with a particular event type 115).

The hashListPointer 340 is a pointer to the next event instance entry whose eventId 305 and eventKey 310 hash to the same hash bucket 350. A key is hashed, even if the key has a variable length. The pseudo-code for hashing on Table 7 (see below) is designed for a faster computation speed. It is noted that other hashing functions can be used in an embodiment of the invention, in order to generate a higher quality hash, but at relatively slower computation speed.

As known to those skilled in the art, a linked list is a data structure in which each element contains a pointer to the next element, thus forming a linear list. A linked list (generally 355) for a selected hash bucket (generally 360) is searched by the event processing code 205 for the particular eventId 305 and eventKey 310, when an event type 115 (associated with the eventId 305) and an event instance 110 (associated with the eventKey 310) has been observed by the network device 105. The hash of the particular eventId 305 and the particular eventKey 310 will point to the proper hash bucket 360. In the example of FIG. 5, the hash buckets 360 include the hash buckets 360(0) to 360(3), although the number of hash buckets 360 may vary. The hash bucket 360(0) has a pointer (hashListPointer 365) to an associated linked list entry 355(0). Each linked list entry 355 will contain the various parameters discussed above to determine if an event instance 110 will be suspended or resumed. The free pool 356 of linked list entries 355(2) to 355(4) is available for use with other event instances 110. When a hash entry (which is formed by one of the linked list entries 355) is deleted, the deleted hash entry is returned to the free pool 356.

If an entry in the hash buckets 360 with a given eventId 305 and eventKey 310 is not found, then an entry is created for these given eventId 305 and eventKey 310, initialized with a count of 0 (zero), and inserted into the hash table 415. If the entry is found, then the entry's count 320 is incremented and compared with an associated threshold value 259 (see FIG. 3) for that eventId 305. If the entry's count 320 exceeds the threshold value 259, then the programmed action 134 for that event type 115 is executed by the event processor code 205.

ThrottleEvent Routine

The ThrottleEvent routine (as shown by the pseudo-code in Table 1) is invoked each time any event instance 110 had occurred or is detected by the hardware 160 and/or software 162 of the network device 105. An eventKey 310 points to the first byte of a key for a particular event instance 110 of the event type 115 in question. The ThrottleEvent routine returns a value of “TRUE” (e.g., logical “1” value) when too many of that particular event instance 110 are observed, and the occurrence of the event instance 110 should be ignored because the number of the particular event instance 110 has exceed an associated threshold value 259. The ThrottleEvent routine is executed in the event processor code 205 (FIG. 2).

TABLE 1
Event Throttling Application Programming Interface (API)

```
boolean ThrottleEvent
    (int eventId, /* Identifies the type of event. */
        void *eventKey /* Pointer to the key for this instance /*
          )
```

Host Packet Throttling Example

The pseudo-code in Table 2 is an example of a host packet throttling routine, in accordance with an embodiment of the invention. If the network device 105 is a DNS server, the following example pseudo-code in Table 2 is used to drop DNS lookup packets 185 for a particular host name when there are too many observed DNS lookup packets 185 for that particular host name.

TABLE 2

if (ThrottleEvent(packetsForHostEventId, &hostname) {
Drop packet;
}

This example pseudo-code is invoked for each DNS request packet 185 received for any host name. The “packetsForHostEventId” parameter identifies the type 115 of event. The “&hostname” parameter is a pointer to the first character of the particular host name. If there are too many packets 185 for the particular host name, the ThrottleEvent routine will return a given value of, for example, TRUE. Additionally, the ThrottleEvent routine may invoke a user defined SuspendAction routine (explained below) to suppress further DNS request packets 185 for the particular host name, so that the DNS packets 185 will be dropped by the rate limiter 135. The ThrottleEvent routine will learn of new host names and create new instances 110 of the events for each new learned host name. Each host event instance 110 will have its own associated count 320 (FIG. 5) and will be throttled independently of other hosts.

Broadcast Packet Example

The pseudo-code in Table 3 is an example of a broadcast packet throttling routine, in accordance with an embodiment of the invention. The pseudo-code in Table 3 is invoked for each broadcast packet 186 that is received by the network device 105, and drops broadcast packets 186 if there are too many broadcast packets 186 at a particular port number of the network device 105 (e.g., if the network device 105 is implemented as an Ethernet switch).

TABLE 3

If (ThrottleEvent(broadcastsFromPortEventId, &portNumber) {
Drop packet;
}

In the network device 105, a count of broadcast packets 186 received at each port number is maintained. If the number of broadcast packets 186 at a particular port number exceeds an associated threshold value 259, then the ThrottleEvent routine will return, for example, a TRUE value. Additionally, the ThrottleEvent routine will invoke a user-defined routine, SuspendAction (if implemented) which could be created, for example, to add or enable a packet filter (hardware filter 178 or software filter 177, for example) for the particular port and suppress further broadcast packets 186 at that particular port number.

Event Creation Routine

The pseudo-code in Table 4 is an example of a create event routine, in accordance with an embodiment of the invention. This pseudo-code is an event 115 creation application program interface (API) that is used for initialization. This routine is called before using the ThrottleEvent( ) routine. For example, when the system 165 (FIG. 1) boots up and will monitor broadcast packets 186 or/and monitor DNS lookup packets 185, or/and monitor other event types 115, a CreateEvent( ) routine will be used for the broadcast packets 186 monitoring and another CreateEvent( ) routine will be used for the DNS lookup packets 185 monitoring. During runtime of the system 165, the ThrottleEvent( ) routine and AgeEvents( ) are called to permit suspension or resumption of an event instance 110.

TABLE 4
Event Creation Application Programming Interface (API)

int CreateEvent (

| | |
|---|---|
| char *eventName, | /* Textual name of the event */ |
| char *eventSuspensionMsg, | /* String to log when event is |
| throttled. */ | |
| char *eventResumptionMsg, | /* String to log when event is |
| resumed. */ | |
| int keyLength, | /* Length of hash key. */ |
| int maxInstances, | /* Number of instances to |
| permit. */ | |
| (void*) ( )KeyToTextConvert | /* Optional caller-supplied |

routine to convert a hash key to text string for logging.
/*

| | |
|---|---|
| int flags, | /* Control and configuration of |
| this event. */ | |
| int suspendThreshold, | /* Threshold above which |
| events are throttled. */ | |
| int resumeThreshold, | /* Threshold below which |

events are resumed (used with RESUME_IF_LOW_RATE flag). */

| | |
|---|---|
| int intervalMs, | /* Each measurement interval, |

event counts are cleared and resumption timers are
checked. Units are in milliseconds, and are a multiple of
system throttle clock (e.g., 50, 100, or 150 for a 50ms
system throttle clock). */

| | |
|---|---|
| int suspensionTime | /* When |
| | RESUME_IF_LOW_RATE |

flag is clear, the event will be resumed after this time
elapses. Units are in milliseconds, and are a multiple of
intervalMs. */

| | |
|---|---|
| int maxAgeMs, | /* Delete the instance if |

older than maxAgeMs. Units are in milliseconds, and
are a multiple of intervalMS */

| | |
|---|---|
| (void*)( ) SuspendAction, | /* Optional caller-supplied |

routine invoked when event is first throttled. */

| | |
|---|---|
| (void*)( ) ResumeAction | /* Optional caller-supplied |

routine invoked when event is resumed. */
);

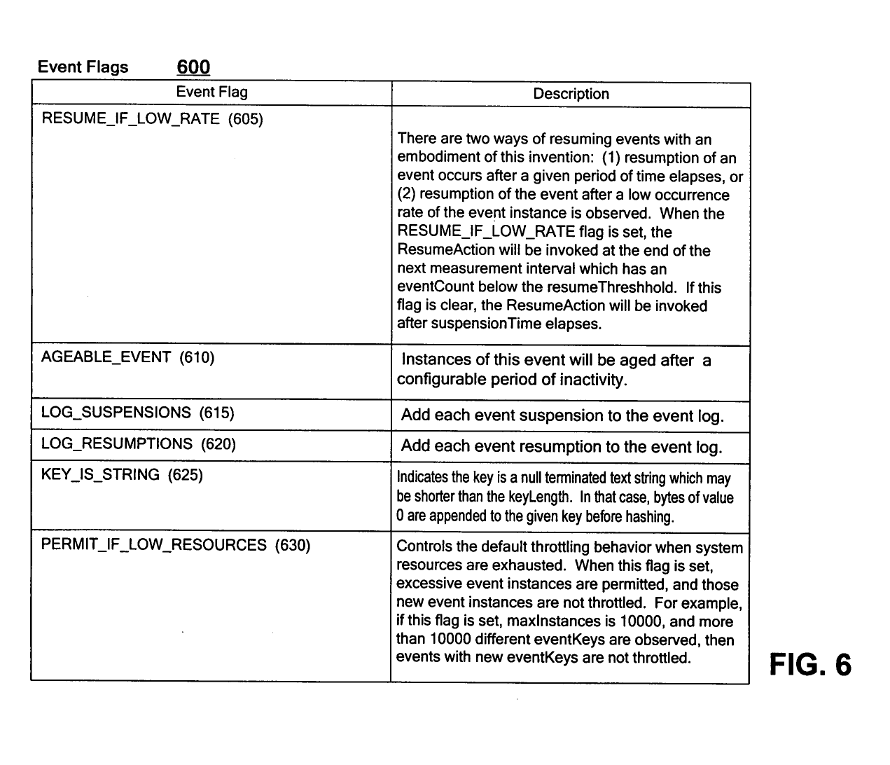

For each new event type 115 (for example, rate limiting of DNS lookup packets 185 or rate limiting of broadcast packets 186) the CreateEvent( ) routine is called. The CreateEvent( ) routine returns an eventId which uniquely identifies the event type 115. The CreateEvent( ) routine is used to specify the rate limit, actions, key length, and other parameters for all instances 110 of the given event type 115. The eventId is used on subsequent calls to the ThrottleEvent( ) routine to indicate the event type 115 that will be rate limited. FIG. 6 further describes the values that are passed as the event flags parameter.

It is further noted that in Table 4, the KeyToTextConvert routine provides an optional caller-supplied routine that converts a hash key into a human-readable text string. For example, if the system 165 is monitoring the number of writes to a particular memory location, then the hash key might be 4 binary bytes (HEX data). The KeyToTextConvert routine might be a routine that knows the symbol table of a computer and will convert the HEX data of the hash key into a human-understandable symbol name.

The time value, suspensionTime, is a counter value for how long an event instance 110 is suspended until the event instance 110 is resumed.

The time value, maxAgeMs, is a counter value used to determine when an entry for an event instance 110 is no longer in use and should be freed up.

FIG. 6 is a table 600 that lists various flags for events 115, as used in accordance with an embodiment of the invention. The flags in table 600 can be set by the user by use of a user interface (e.g., system logging interface 225 in FIG. 2) and the flag values can be stored in memory (e.g., the flag values are stored in the event state database 235).

The RESUME_IF_LOW_RATE flag 605 controls whether or not to resume an event 115 after a certain time period has elapsed or to resume an event 115 after a low occurrence of the event 115. There are two ways of resuming events 115 with an embodiment of this invention: (1) resumption of an event 115 occurs after a given period of time elapses, or (2) resumption of an event 115 occurs after a low occurrence rate of the event type 115 are observed (e.g., the value of the suspended event instance falls below the resumption threshold value 260). When the RESUME_IF_LOW_RATE flag 605 is set (set to TRUE), the ResumeAction routine will be invoked at the end of the next measurement interval (set by intervalNum 263 in FIG. 3) which has an eventCount 320 below the resumeThreshold 260. If the RESUME_IF_LOW_RATE flag 605 is clear (set to FALSE), the ResumeAction routine will be invoked after suspensionTime 261 elapses. The ResumeAction routine is an optional caller-supplied routine invoked when an event 115 is resumed. The event aging and resumption code 215 will typically read the value of the RESUME_IF_LOW_RATE flag 605.

The AGEABLE_EVENT flag 610 indicates if instances 110 of an event 115 will be aged after a configurable period of inactivity. As discussed above, when an event instance 110 is not observed by the network device 110 within a maxAge time period 264, then an identifier eventKey 310 of that event instance 110 is deleted. The event aging and resumption code 215 will typically read the value of the AGEABLE_EVENT flag 610.

The LOG_SUSPENSIONS flag 615 is a flag that indicates if a suspension of an event type 115 will be logged. Each event suspension is added to the event log 226 (FIG. 2) when LOG_SUSPENSIONS is true. The event processor code 205 will typically read the value of the LOG_SUSPENSIONS flag 615.

The LOG_RESUMPTIONS flag 620 is a flag that indicates if a resumption of an event type 115 will be logged. Each event resumption is added to the event log 226 when LOG_RESUMTIONS is true. The event aging and resumption code 215 will typically read the value of the LOG_RESUMPTIONS flag 620.

The KEY_IS_STRING flag 625 indicates that a given key is a null terminated text string which may be shorter than the keyLength 255 (FIG. 3). In that case, bytes of value zero (0) are appended to the given key before hashing. The event processor code 205 will typically read the value of the KEY_IS_STRING flag 625.

The PERMIT_IF_LOW_RESOURCES flag 630 is a flag that controls that behavior of the system 165 if there are not enough resources in the system 165 to track all of the event instances 110. For example, assume that the system 165 has resources (e.g., memory resources) to track broadcast packets 186 at approximately 100 ports of the network device 105, but the network device 105 actually has approximately 200 ports. If the PERMIT_IF_LOW_RESOURCES flag 630 is set to true, then broadcast packets 186 through the last 100 observed ports will be permitted, even if they would have otherwise been throttled. If the PERMIT_IF_LOW_RESOURCES flag 630 is set to false, then broadcast packets 186 through the last 100 observed ports (e.g., ports B1-B100) will be dropped, even though they would otherwise have been permitted. Therefore, the PERMIT_IF_LOW_RESOURCES flag 630 controls the default throttling behavior when system 165 resources are exhausted. When the PERMIT_IF_LOW_RESOURCES flag 630 is set, excessive event instances 110 are permitted, and those new event instances 110 are not throttled. For example, if the PERMIT_IF_LOW_RESOURCES flag 630 is set, maxInstances is 10000, and more than 10000 different eventKeys are observed, then events 115 with new eventKeys are not throttled.

As another example, assume that an Internet Service Provider (ISP) will limit DNS lookup packets 185 to approximately 20 event instances 110, and the ISP has approximately 10 different servers that will be looked up. If the PERMIT_IF_LOW_RESOURCES flag 630 is set to false, then DNS lookups will be dropped if the event instances 110 exceed the threshold value of 20 in this example. As a result, an embodiment of the invention provides protection against DOS attacks of DNS lookups for random host names, since event instances will be created for the first 20 host names, but lookups for additional host names will be dropped.

The event processor code 205 will typically read the value of the PERMIT_IF_LOW_RESOURCES flag 630.

When not using the RESUME_IF_LOW_RATE flag 605 (i.e., when using time-based event resumption), the ageInterval 263 should be greater than suspensionTime 261. If this setting is not made, the event 115 entry, eventEntry, could age out before the suspensionTime 261 elapses, causing the event 115 to be resumed at an earlier time than intended.

The RESUME_IF_LOW_RATE flag 605 should not be used when a SuspensionAction routine is used. If the RESUME_IF_LOW_RATE flag 605 is used, the SuspensionAction routine may halt the event 115 through some external method or feature, which would in turn cause the algorithm to detect a low event rate and resume the suspended event 115 immediately.

An embodiment of this invention is ideally suited for situations that require an immediate suspension of events 115 that exceed the threshold value 259, but can use a slow event resumption time. If a very quick reaction to events 115 with low rates is needed, to quickly resume the suspended events 115, then the intervalMs parameter 263 (FIG. 3) is required to be reduced at the cost of reduced system performance.

Host Packet Throttling Example

The pseudo-code in Table 5 is an example of creating an event 115 for a DNS lookup, in accordance with an embodiment of the invention.

TABLE 5
packetsForHostEventID = CreateEvent (
“DNS lookup packets for host”, /* eventName */
“Excessive packets have been suppressed”, /*
eventSuspensionMsg */
“Packets have been resumed”, /* eventResumptionMsg */
255, /* keyLength */
10000, /* maxInstances */
0, /* KeyToTextConvert */
LOG_SUSPENSIONS | LOG_RESUMPTIONS | KEY_IS_STRING |
AGEABLE_EVENT, /* flags */
100, /* suspendThreshold */
0, /* resumeThreshold */
2000, /* 2 sec. intervalMs */
10000, /* 10 sec. suspensionTime */
30000, /* 30 second age time. */
&StopPacketsForHost, /* SuspendAction */
&ResumePacketsForHost, /* ResumeAction */
);

The specific example pseudo-code in Table 5 creates an eventId 305 that is used to drop packets for approximately 10 seconds when there are over one-hundred (100) DNS name lookup packets 185 for a particular host in a 2-second period of time. In this example system, there are thousands of hosts, and, therefore, maxInstances 256 has a value of 10,000. The system throttle clock is approximately 50 millisecond (this time value is normally set at compile time using a “#define” parameter). The measurement time interval (“intervalMs” or intervalNum 263 in FIG. 3) is approximately 2 seconds. If more than 100 DNS lookup packets 185 are received within 2 seconds for a particular host name, the StopPacketsForHost( ) routine is called to perform any action(s) 134 to stop (filter) the packets 185 for the particular host name for approximately 10 seconds. The 10 seconds suspension time value is set in the suspensionTime 261 parameter. After the suspension time of 10 seconds has elapsed, the ResumePacketsForHost( ) routine will be called to perform any action(s) 134 that are needed to re-enable the DNS lookup packets 185 for the host name. In other words, the ResumePacketsForHost( ) would remove or disable the packet filter (e.g., hardware filter 178 or software filter 177). The StopPacketsForHost( ) routine could be designed to add a filter which causes an Ethernet switch to drop those particular DNS lookup packets 185, so that the packets 185 do not reach the DNS lookup packet processing software in a DNS server.

Note that a SuspendAction routine (e.g., the StopPacketsForHost routine), ResumeAction routine (e.g., the ResumePacketsForHost routine), and KeyToTextConvert routine (which is unused in this example because the eventKey value is the textual host name) are all optional custom caller supplied routines that are written for the particular event type 115.

Pseudo-Code for ThrottleEvent API

The pseudo-code in Table 6 is an example for the throttle event routine which is called at runtime to monitor if a given event 115 exceeds a threshold value 259, in accordance with an embodiment of the invention. For increased performance, the ThrottleEvent routine may be declared as an “inline” function, and the exception cases of this routine should be moved into separate subroutines.

TABLE 6
Pseudo-Code For ThrottleEvent API

```
boolean ThrottleEvent (int eventID, void* eventKey)
hashValue = hash (eventId, eventKey,
            events[eventId].keyLength)
Search list of the given hashValue. Look for entry with
matching eventId and eventKey.
if found
  /*The aging process requires that the age be cleared
    when the event instance is observed.
  */
  entry -> age = 0
  if (entry -> count >= events[eventId].threshold) {
  /* The threshold has been reached.
  *
  * To avoid a counter wraparound problem, stop
  * incrementing the count when the event is
  * suspended.
  *
  *
  * Suspend the event if it has not already been
  * suspended */
  if !entry -> suspendFlag {
    if events[eventId].flags & LOG_SUSPENSIONS
        log events[eventId]. eventName,
          entry -> eventKey,
          events[eventId].eventSuspendedMsg
    invoke events[eventId].SuspendAction(eventKey)
    events[eventId].numSuspendedInstances++
    entry -> suspendedFlag = 1
    /* Start timer for when event instance will be
      resumed */
    if (! events[eventId].flags
        RESUME_IF_LOW_RATE)
        entry -> suspendCountDownTimer =
            events[eventId].suspensionTime
    }
    return(TRUE); /* Throttle this event */
  }
  else {
    /* The threshold has not been reached. */
    /* Increment the count of observations for this
      interval */
    entry -> count++
    /* To improve performance, automatically move the
    * active entries towards the front of the linked
    * list. When an entry is found, swap it with the
    * entry that precedes it. This will cause active
    * entries to be at the front of the list, and
    * idle entries will go to the end of the list.
    * Define MOVE_FREQUENCY as 4 to cause shuffling
    * every fourth event.
    */
    if (entry -> count % MOVE_FREQUENCY == 0)
      if this entry is not the head of the linked
      list of this hashValue, swap current and
      previous entries.
    /* Don't throttle this event. */
    return{FALSE};
    }
}
else {
    /* The eventId and eventKey were not found. This
      is a new instance. */
    if [eventId].numInstances >= event
      [eventId].maxInstances {
        /* Too many event keys. Throttle,
          depending on configured behavior.*/
        return(!events[eventId].flags &
        PERMIT_IF_LOW_RESOURCES);
    }
    entry = allocateNewEntryFromFreePool( );
    if entry == NULL {
        /* Too many event keys. Throttle,
          depending on configured behavior.*/
        return(!events[eventId].flags &
        PERMIT_IF_LOW_RESOURCES);
    }
    Initialize fields in event instance entry
    link entry into the front of the list
      at hashBucket[hash]
    link entry into the front of the list at
      events[eventId].eventInstanceList
      events[eventId].numInstances++
    /* Threshold not exceeded. Do not throttle this
    event. */
  return(FALSE);
}
```

Pseudo-Code for Hashing

The pseudo-code in Table 7 is an example for a hashing routine, in accordance with an embodiment of the invention. The hash function is tuned for arbitrary length keys, with for example, approximately 257 to 6,5536 hash buckets 360 (FIG. 5). If only 256 hash buckets 360 are needed, an even quicker hash function can be created which adds up the bytes of the key and returns an 8 bit result. In those systems with a fixed-length search key, performance can be increased by removing the check for a null terminated string in the search key. In those systems with one eventId 305 and a one or two byte keyLength 255, and eventKey 310 could be used directly, and hashing would not be required at all.

TABLE 7
Pseudo-Code For Hashing

```
unsigned int hash(int eventId, (void*) eventKey, int
            keyLength)
{
  int sum = 0;
  boolean keyIsString = events[eventId].flags &
    KEY_IS_STRING
  for (i=0 ; i<keyLength ; i++)
      if (keyIsString && !*eventKey)
        /* Exit loop when the end of a null-
          terminated string is reached.*/
        break;
      if (i%2)
        sum = sum + (*eventKey++)<<8;
      else
        sum = sum + *eventKey++
  }
  return (sum & (NUM_HASH_BUCKETS−1) )
}
```

Pseudo-Code for Event Creation

The pseudo-code in Table 8 is an example for an event creation routine, in accordance with an embodiment of the invention. This routine is called when the system 165 (FIG. 1) initializes.

TABLE 8
Pseudo-Code For Event Creation

int CreateEvent(
char *eventName, /* Textual name of the event */

| | |
|---|---|
| char *eventSuspensionMsg, /* | String to log when event is |
| | throttled. */ |
| char *eventResumptionMsg, /* | String to log when event is |
| | resumed. */ |

| | |
|---|---|
| uint32 keyLength, /* | Length of hash key. */ |
| int maxInstances, /* | Number of instances to permit. |
| | Instances exceeding this limit are |
| | ignored. */ |

| | |
|---|---|
| (void*)( ) KeyToTextConvert, /* | Optional caller-supplied |
| | routine to convert a hash |
| | key to a text string for |
| | logging. */ |

int flags, /* Control and configuration of this event. */

| | |
|---|---|
| uint32 suspendThreshold, /* | Threshold above which events |
| | are throttled. */ |
| uint32 resumeThreshold, /* | Threshold below which events |
| | are resumed (used with |
| | RESUME_IF_LOW_RATE flag). */ |

| | |
|---|---|
| int intervalMs, /* | Each measurement interval, event |
| | counts are cleared and resumption |
| | timers are checked. Units are in |
| | milliseconds, and are a multiple of |
| | the system throttle clock (e.g., 50, |
| | 100, or 150 for a 50ms system |
| | throttle clock). */ |

| | |
|---|---|
| int suspensionTime, /* | When RESUME_IF_LOW_RATE is clear, |
| | the event will be resumed after |
| | this time elapses. Units are in |
| | milliseconds, and are a multiple |
| | of intervalMs. */ |

| | |
|---|---|
| int maxAgeMs, /* | Delete the instance if older than |
| | maxAgeMs. Units are in milliseconds, |
| | and are a multiple of intervalMs */ |

| | |
|---|---|
| (void*){ } SuspendAction, /* | Optional caller-supplied |
| | routine invoked when event |
| | is first throttled. */ |
| (void*){ } ResumeAction, /* | Optional caller-supplied |
| | routine invoked when event |
| | is resumed. */ |

```
  )
{
  entry = first available entry in events[] array
  eventId = ID of the entry
  Copy the following parameters into their corresponding
  field in events[eventId]:
    eventName, eventSuspensionMsg, eventResumptionMsg,
    keyLength, maxInstances, KeyToTextConvert, flags,
    suspendThreshold, resumeThreshold, intervalMs,
    SuspendAction, ResumeAction
  /* Set suspensionTime to the number of intervals to
  suspend. */
  events[eventId].suspensionTime= suspensionTime /
                              intervalMs
  /* Set maxAge to the number of intervals for aging. */
  events[eventId].maxAge = maxAgeMs / intervalMs
  return(eventId)
}
```

Pseudo-Code for Event Aging and Event Resumption

The pseudo-code in Table 8 is an example for an event aging and event resumption routine, in accordance with an embodiment of the invention. This routine runs periodically to determine if an event instance 110 should be freed up (aged out) or if a suspended event instance 110 should be resumed. The AgeEvents routine is executed once per each system throttle clock. In the below example, the system throttle clock is approximately 50 milliseconds. Event instances 110 that have not been used (observed) for the age-out time period (which is configured by using the maxAge parameter 264 in FIG. 3) are deleted, in order to make room in memory for new event instances 110 to be monitored.

Also a check is performed to determine if the time has occurred to resume any of the currently suspended event instances 110.

TABLE 9
Pseudo-Code For Event Aging and Event Resumption

```
void AgeEvents( )
for eventId = 0 to MAXEVENTIDS−1 {
  if (events[eventId].flags == 0)
    /* If this event ID is not in use, continue on to
      next eventId */
    continue
  if (++events[eventId].intervalNum <
      events[eventId].throttleClocksPerInterval)
  /* If it is not time to do aging on this eventId,
  * then continue for loop with next eventId. */
  continue
ageable = events[eventId].flags & AGEABLE_EVENT
resumeinTime = !(events[eventId].flags &
      RESUME_IF_LOW_RATE)
events[eventId].intervalNum = 0
entry = events[eventId].eventInstanceList
while (entry !=NULL) {
  entry -> age++
  /* See if the entry has not been used for a while
      and can be aged out. */
  if (ageable &&
    (entry -> age > events[eventId].maxAge)) {
      /* Entry needs to be aged out. First,
      * see if the event needs to be resumed.
      */
      if event at entry is suspended {
        /* Resume the suspended event
        * before we delete it.
        * Note: this code fragment
        * should not be needed in
        * a properly configured system.
        */
        if events[eventId].flags &
        LOG_RESUMPTIONS
        Log
          events[eventId].eventName,
          entry->eventKey,
          events[eventId].
            eventSuspendedMsg
      call
        events[eventId].
        ResumeAction(&(entry -> key))
        events[eventId].
        numSuspendedInstances--;
    }
    events[eventId].numInstances--;
    unlink the entry from the hashBucket
      list and eventInstanceList
    delete the entry and return it to the
      free pool.
  }
  else {
    /* See if event needs to be resumed */
    if (entry -> suspendedFlag) {
      if (resumeInTime) {
        if (-- (entry ->
          suspendCountDownTimer)<=0) {
            /* Time to resume
            * the event */
            if events[eventId].
              flags &
              LOG_RESUMPTIONS
              Log
              events[eventId].
              eventName,
                entry ->
                  eventKey,
      events[eventId].eventSuspendedMsg
        call
        events[eventId].ResumeAction(
              & (entry -> key))
        entry -> suspendedFlag = 0
  events[eventId].numSuspendedInstances--;
  }
  else if (entry -> count <
    events[eventId].resumeThreshold) {
          /* Resume the event
          */
          if
    events[eventId].flags & LOG_RESUMPTIONS
              log
        events[eventId].eventName,
                entry ->
                  eventKey,
        events[eventId].eventSuspendedMsg
            call
          events[eventId].ResumeAction(
              &(entry -> key))
            entry ->
              suspendedFlag = 0
      events[eventId].numSuspendedInstances--;
      }
    /* Clear count of event occurrences in this
    * measurement interval */
    entry -> count = 0
    go to next entry in list
  } /* while entry != NULL */
} /* For all eventIds */
```

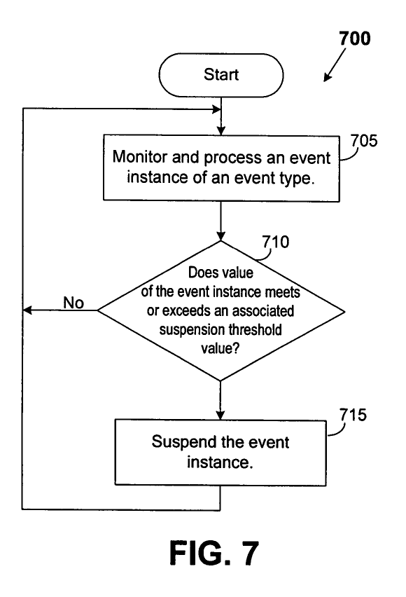

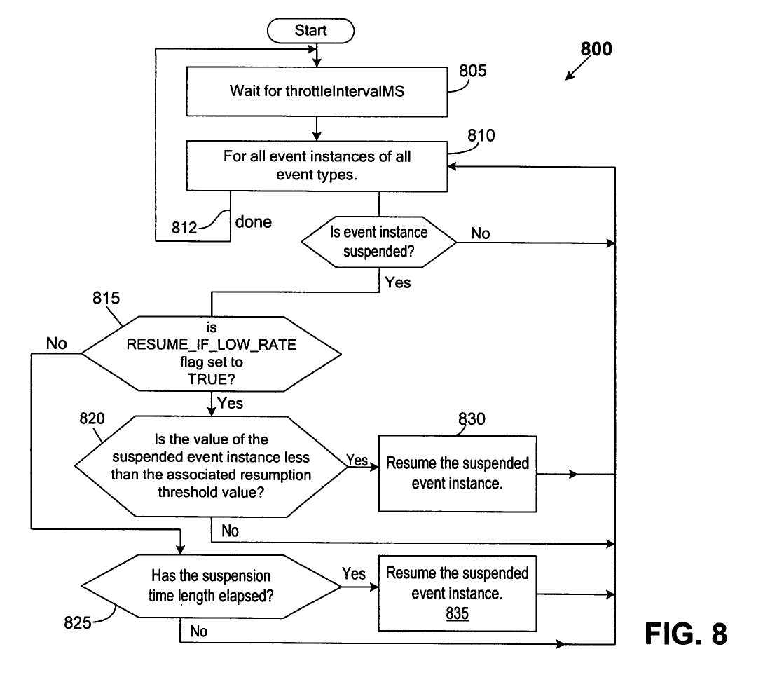

FIG. 7 is a flowchart of a method 700 for rate limiting of events in a network, and FIG. 8 is a flowchart of a method 800 for event resumption and aging, in accordance with embodiments of the invention. In block 705, an event instance of an event type is monitored and processed. In block 710, a check is performed to determine if a value of the event instance meets or exceeds an associated suspension threshold value. If the value of the event instance is less than the associated suspension threshold value, then the method 700 returns to block 705 to continue in monitoring and processing the event instance. On the other hand, if the value of the event instance exceeds the associated suspension threshold value, then the method 700 proceeds to block 715.

In block 715, the event instance is suspended.

The method 700 performs the rate limiting process as shown in the flow chart of FIG. 7 for all event instances. The method 800 performs the event resumption and aging process as shown in the flow chart of FIG. 8 for all event instances.

In block 805, the method 800 waits for a time period equal to throttleIntervalMS which is the system throttle clock controlling all periodic checking to see which event instances need to be resumed or aged.

In block 810, for each suspended event instance 110 of all event types 115, the method 800 proceeds to block 813. When there are no more suspended event instances, then the check performed in block 810 is done (completed) and the method 800 returns to block 805 via line 812 to wait until the next system throttle clock interval.

In block 813, a check is to perform to determine if the event instance is currently suspended. This check tests the suspendedFlag 325 of the event instance 355. If the event is suspended, then control proceeds to block 815. Otherwise, control returns to block 810.

In block 815, a check is performed to determine if the event instance should be resumed based on a low rate, or if the resumption criteria is based on time. This check is performed by determining if the RESUME_IF_LOW_RATE flag has a value of TRUE or FALSE, as previously described above. If it should be resumed based on a low rate, block 820 is performed. If it should be resumed based on time, block 825 is performed.

In block 820, a check is performed to determine if the value of the suspended event instance is less than the associated resumption threshold value. If the value of the suspended event instance is less than the associated resumption threshold value, then the suspended event instance is resumed in block 830 and the method 800 then returns to block 810. If the value of the suspended event instance is greater than or equal to the resumption threshold value, then the method 800 proceeds to block 810.

In block 825, a check is performed to determine if the suspension time length has elapsed. If the suspension time length has elapsed, then the suspended event instance is resumed in block 835 and the method 800 then returns to block 810. If the suspension time length has not elapsed, the method 800 returns to block 810.

Therefore an embodiment of the invention provides a general purpose apparatus and method for rate limiting of events 115 and can support many options in the rate limiting of different types 115 of events. Embodiments of the invention support many options or features or combinations of options or features as discussed above.

It is also within the scope of the present invention to implement a program or code that can be stored in a machine-readable medium to permit a computer to perform any of the methods described above.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing disclosure.

It will also be appreciated that one or more of the elements depicted in the drawings/figures can also be implemented in a more separated or integrated manner, or even removed or rendered as inoperable in certain cases, as is useful in accordance with a particular application.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for rate limiting of events, the method comprising:
monitoring and processing an event instance of an event type; and
if a value of the event instance to be monitored meets or exceeds an associated suspension threshold value, then performing a user-defined action for the event instance.

2. The method of claim 1, wherein a value of the event instance to be monitored is a count of the event instance in an interval time period.

3. The method of claim 1, wherein the act of performing the user-defined action comprises suspending the event instance.

4. The method of claim 1, wherein the event instance is suspended for a suspension time length.

5. The method of claim 1, further comprising:
resuming the suspended event instance.

6. The method of claim 5, wherein the act of resuming comprises:
resuming the suspended event instance after a suspension time length has elapsed.

7. The method of claim 5, wherein the act of resuming comprises:
resuming the suspended event instance after a value of the event instance falls below the resumption threshold value.

8. The method of claim 5, wherein the act of resuming comprises:
resuming the suspended event instance after a value of the event instance falls below the suspension threshold value.

9. The method of claim 1, further comprising:
logging a suspension of the event instance.

10. The method of claim 1, further comprising:
logging a resumption of the suspended event instance.

11. The method of claim 1, further comprising;
deleting an identifier, eventKey, associated with the event instance, if the event instance does not occur within a maximum age time value.

12. The method of claim 1, wherein the event type is associated with a Domain Name Service (DNS) lookup request.

13. The method of claim 12, wherein the event instance is a DNS look request packet for a particular host name.

14. The method of claim 1, wherein the event type is a broadcast packet.

15. The method of claim 14, wherein the event instance is a broadcast packet from a particular port.

16. The method of claim 1, wherein the event type is a Simple Network Management Protocol (SNMP) packet.

17. The method of claim 16, wherein the event instance is an SNMP packet from a particular host.

18. The method of claim 1, wherein the act of monitoring comprises counting a number of observed event instances and performing a hash operation on an identifier, eventId, of the event type and an identifier, eventKey, of the event instance.

19. The method of claim 1, wherein the event type is associated with an event identifier (eventId).

20. The method of claim 1, wherein the event instances is associated with an event key identifier (eventKey).

21. The method of claim 1, further comprising:
deleting a data structure associated with the event instance if the event instance is not observed within a maximum age time value.

22. An apparatus for rate limiting of events, the apparatus comprising:
a rate limiter configured to monitor and process an event instance of an event type, and perform a user-defined action for the event type, if a value of the event instance to be monitored meets or exceeds an associated suspension threshold value.

23. The apparatus of claim 22, wherein a value of the event instance to be monitored is a count of the event instance in an interval time period.

24. The apparatus of claim 22, wherein the rate limiter is configured to perform the user-defined action by suspending the event instance.

25. The apparatus of claim 22, wherein the event instance is suspended for a suspension time length.

26. The apparatus of claim 22, wherein the rate limiter is configured to resume the suspended event instance.

27. The apparatus of claim 26, wherein the rate limiter is configured to resume act the suspended event instance after a suspension time length has elapsed.

28. The apparatus of claim 26, wherein the rate limiter is configured to resume the suspended event instance after a value of the event instance falls below the resumption threshold value.

29. The apparatus of claim 26, wherein the rate limiter is configured to resume the suspended event instance after a value of the event instance falls below the suspension threshold value.

30. The apparatus of claim 22, wherein the rate limiter is configured to log a suspension of the event instance.

31. The apparatus of claim 22, wherein the rate limiter is configured to log a resumption of the suspended event instance.

32. The apparatus of claim 22, wherein the rate limiter is configured to delete an identifier, eventKey, associated with the event instance, if the event instance does not occur within a maximum age time value.

33. The apparatus of claim 22, wherein the event type is associated with a Domain Name Service (DNS) lookup request.

34. The apparatus of claim 33, wherein the event instance is a DNS look request packet for a particular host name.

35. The apparatus of claim 22, wherein the event type is a broadcast packet.

36. The apparatus of claim 35, wherein the event instance is a broadcast packet from a particular port.

37. The apparatus of claim 22, wherein the event type is a Simple Network Management Protocol (SNMP) packet.

38. The apparatus of claim 37, wherein the event instance is an SNMP packet from a particular host.

39. The apparatus of claim 22, wherein the rate limiter is configured to count a number of observed event instances and perform a hash operation on an identifier, eventId, of the event type and an identifier, eventKey, of the event instance.

40. The apparatus of claim 22, wherein the event type is associated with an event identifier (eventId).

41. The apparatus of claim 22, wherein the event instance is associated with an event key identifier (eventKey).

42. The apparatus of claim 22, wherein the rate limiter is configured to delete a data structure associated with the event instance if the event instance is not observed with a maximum age time value.

43. An article of manufacture, comprising:
a machine-readable medium having stored thereon instructions to:
monitor and process an event instance of an event type; and
perform a user-defined action for the event instance, If a value of the event instance to be monitored exceeds an associated suspension threshold value.

44. An apparatus for rate limiting of events, the apparatus comprising:
means for monitoring and processing an event instance of an event type; and
means for performing a user-defined action for the event instance, if a value of the event instance to be monitored meets or exceeds an associated suspension threshold value.
